(19) United States
(12) Patent Application Publication
(10) Pub. No.: US 2010/0321258 A1
(43) Pub. Date: Dec. 23, 2010

(54) ANTENNA PANEL FOR A MOTOR-VEHICLE WINDOW

(75) Inventors: Thomas Lankes, Rosenheim (DE); Anton Ilsanker, Riedering (DE); Gerald Schillmeier, Munchen (DE); Bulent Solan, Rosenheim (DE)

Correspondence Address: NIXON & VANDERHYE, PC, 901 NORTH GLEBE ROAD, 11TH FLOOR, ARLINGTON, VA, 22203, US

(73) Assignee: KATHREIN-WERKE KG, Rosenheim (DE)

(21) Appl. No.: 12/920,411

(22) PCT Filed: Mar. 26, 2009
(86) PCT No.: PCT/EP09/02235

§ 371 Date: Aug. 31, 2010

(30) Foreign Application Priority Data
Apr. 3, 2008 (DE) 10 2008 017 052.6

(51) Int. Cl. H01Q 1/32

(52) U.S. Cl. 343/712

(57) ABSTRACT

An improved antenna field has at least one capacitance switched between one of the two bus bars. At least one center section of the heating wire is formed between 20% and 80% of the total length of the heating wire, and/or at least one capacitance is switched between at least two center sections of the heating wires formed between 20% and 80% of the total length of two heating wires. The at least one capacitance is greater than 50 pF.

The invention relates to an antenna panel for a motor-vehicle window, in particular a motor-vehicle rear window, according to the preamble of claim 1.

It is well known that, for example, a heating panel provided in the rear widow of a passenger vehicle can also be used as an antenna panel. Usually a bus bar is provided in the rectangular or trapezoidal rear window on the left-hand side and right-hand side, between which the individual heating wires run in a mutually parallel direction. Each of the two bus bars is connected to the pole of a vehicle battery.

Secondary conductors running in a transverse direction, which are fundamentally suited to improving the reception qualities of such a rear-window antenna, can be provided along equipotential lines. Since these secondary conductors run along said equipotential lines, it is fundamentally guaranteed that cross-currents cannot flow between the heating wires here.

Such a rear-window heater acting as an antenna panel can comprise one or more heating panels. It is also possible that a separate or additional antenna panel is provided in addition to the heating panel. Even if just one antenna panel that was entirely separate form the heating panel were provided in a window, in particular in the rear window, of the motor vehicle, the heating panel lying adjacent to it would interfere with the antenna panel, i.e. it would ultimately influence the reception quality of the antenna panel.

The antenna panels and/or heating panels situated in the rear windows are often used for receiving broadcasts, in particular for receiving radio and TV programmes in the LW, MW, SW, VHF and/or microwave region.

DE 100 33 336 A1, DE 43 21 805 A1, EP 1 366 540 B1 and DE 43 23 239 C2 disclose relevant heating panels and/or antenna panels. It is also disclosed, for example in the aforementioned DE 100 33 336 A1 in a variation shown in FIG. 6, that a capacitance is additionally connected between the two bus bars.

Finally, DE 195 41 083 A1 discloses a window antenna for a rear window, where the heating panel also acts as an antenna system. In this prior publication, the proposed solution is to create a window antenna that affords a better rear view for the driver. The antenna itself comprises for this purpose a multiplicity of heating wires aligned substantially in a horizontal direction and spaced apart parallel to each other, said wires running from a left-hand bus bar to a right-hand bus bar. In the centre, a conductor wire is provided that runs in a transverse direction to said wires along a central equipotential line, said wire making a direct current connection between the multiplicity of heating wires running at right angles to it. Finally, yet another shorter conductor wire is arranged along the top heating wire and parallel to it, which results in a capacitive coupling to the adjacent heating wire. This conductor wire then provides the antenna tap-off. According to this prior publication, the capacitance is meant to be less than 40 pF because it would be pointless to increase the coupling capacitance above 40 pF.

The object of the present invention is to create an improved antenna panel that is incorporated in a window, said antenna panel being composed entirely or partially of the heating panel or containing it and/or being provided in addition to the heating panel as a separate sole or additional antenna panel.

The object is achieved according to the invention by the features given in claim 1. The subclaims contain advantageous embodiments of the invention.

Based on completely novel forms of the heating panel design, the invention now provides appropriate modification measures for improving the reception quality of an antenna panel incorporated in the window. The advantages according to the invention are achieved, however, not only when the entire heating panel is also used as the antenna panel, but especially also when the heating panel is split into a plurality of heating panels, when individual heating panels, for example, also act as an antenna panel, or even when a pure antenna panel is provided that is separate from the one or more heating panels.

The present invention is based on a bus-bar structure, in which the two bus bars are preferably provided entirely or substantially on one side, generally on the lower window side usually running more or less horizontally. it shall also be possible within the scope of the invention that the two bus bars are not provided entirely or substantially on opposite sides of a window or a windscreen, i.e. for example are provided entirely or partially on the lower side of a window and entirely or partially on a right-hand or left-hand side of the motor-vehicle window.

In particular for such an embodiment (although also for conventional embodiments having bus bars provided on opposite sides in the motor-vehicle windows), an improvement in the antenna property, in particular the reception quality, is achieved, for example, by connecting by means of a capacitance a bus bar and a preferably central section of a heating wire (where the central section shall lie between 20% and 80% of the total length of a corresponding heating wire). Alternatively and additionally, however, such a capacitance can also be connected between two heating wires connected to the respective bus bars, namely preferably between a central section of two corresponding heating wires, where the central section of the two heating wires likewise shall again lie preferably between 20% and 80% of the total length of the relevant heating wire.

Said capacitances, i.e. the at least one capacitance in each case, shall here be connected and/or provided if possible in a direct connection between the relevant connection points on the bus-bar sections and/or the preferably central sections of said heating wires, because preferably other components such as an inductance may also be provided, if applicable, in addition to the capacitance, creating a series resonant circuit.

This capacitance is preferably provided still within the height of the window material. Preferably here the capacitance is implemented in the form of a discrete or lumped component.

The at least one capacitance can here be soldered on via wires, for instance as an electrolytic capacitor. Ceramic capacitors, flexible printed circuit boards etc. are also possible.

An advantageous size for the capacitance is between 50 pF and 10 μF for example. Often values greater than 0.1 nF or greater than 0.1 μF and in particular greater than 0.5 nF or greater than 0.5 μF are sufficient for VHF reception.

It is fundamentally possible to implement the capacitive coupling also by a plurality of series-connected capacitors or, for example, also by a series resonant circuit composed of capacitor and inductor etc. A centre tap between two series-connected capacitors, which is connected to ground directly or e.g. via a choke (in particular to the car-body ground), would also come into question. Connecting a plurality of capacitances via ground, however, would have a negative impact on the antenna properties and reception qualities.

To summarise, it can be established that the solution according to the invention makes it possible to realise antenna properties that have a lower frequency dependence, i.e. a higher bandwidth, than a comparable antenna and heating panel. In addition, within the scope of the invention it is possible to suppress or shift the resonant behaviour of the heating conductor for high frequency signals.

The invention is particularly suitable for new geometries of heating panels. Hence the invention has particular advantages when heating panels are used that comprise, for instance, heating conductors that are spaced apart from each other in a trapezoidal arrangement or even heating conductors formed as concentric circles or ovals etc. Since, in principle, the heating conductors should have a similar total length (so that an approximately comparable thickness of the heating conductors is achieved, in order to produce comparable total resistances per heating wire), it is conceivable, for a heating panel made of concentric circles in a comparable arrangement, to connect at one end inner heating conductors in order to produce heating wires that have a greater total length. in this case, it is possible likewise to connect at the relevant points at least one capacitance in each case directly to one of the bus bars and/or even between the heating conductors themselves or between a heating conductor and a bus bar, said capacitance(s) helping to provide similar improvements in the antenna panel to those that were explained above for the capacitance connected between the bus bars. This is particularly relevant when, because of conductors being connected together to produce heating conductors having a greater total length, it is not possible to connect secondary conductors lying along equipotential lines.

Further advantages, details and features of the invention will emerge below from the exemplary embodiment which is shown in the drawings, in which:

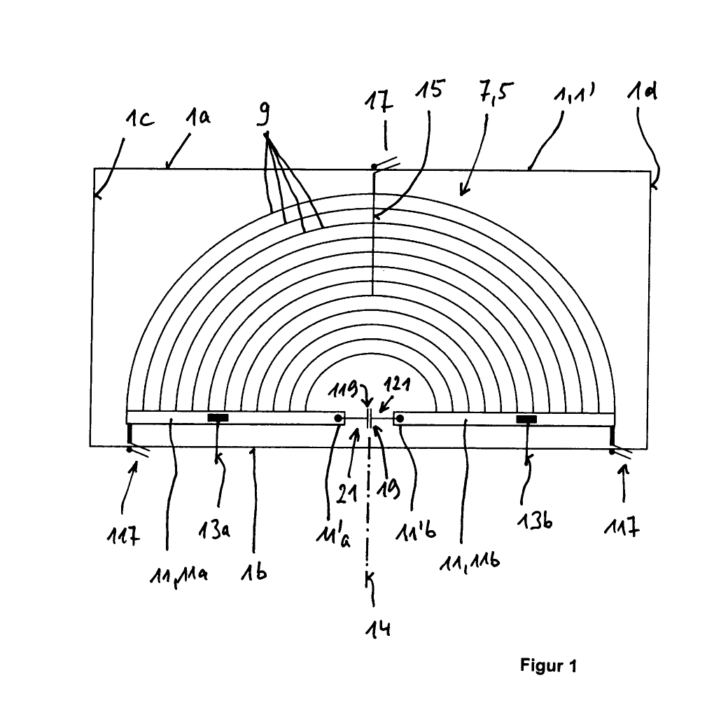

FIG. 1 shows a first schematic diagram of an exemplary embodiment of a heating panel and antenna panel that is not part of the invention, which is incorporated in a window of a motor vehicle;

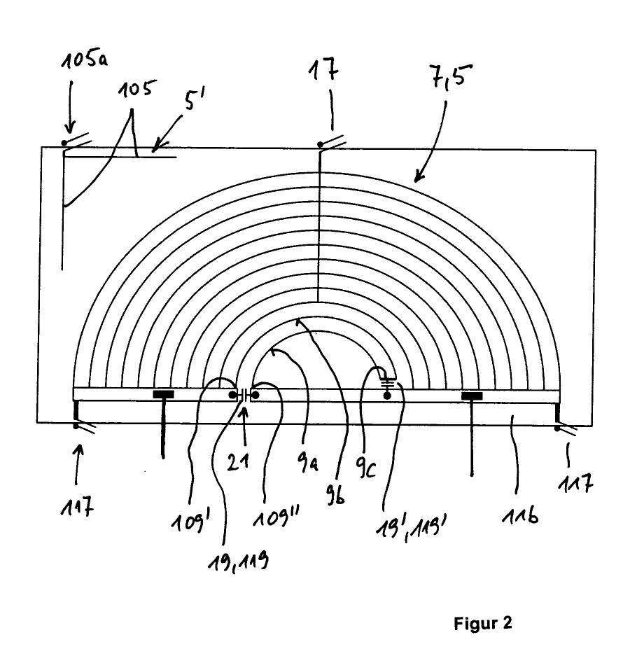

FIG. 2 shows a modified exemplary embodiment according to the invention having two innermost heating conductors connected together;

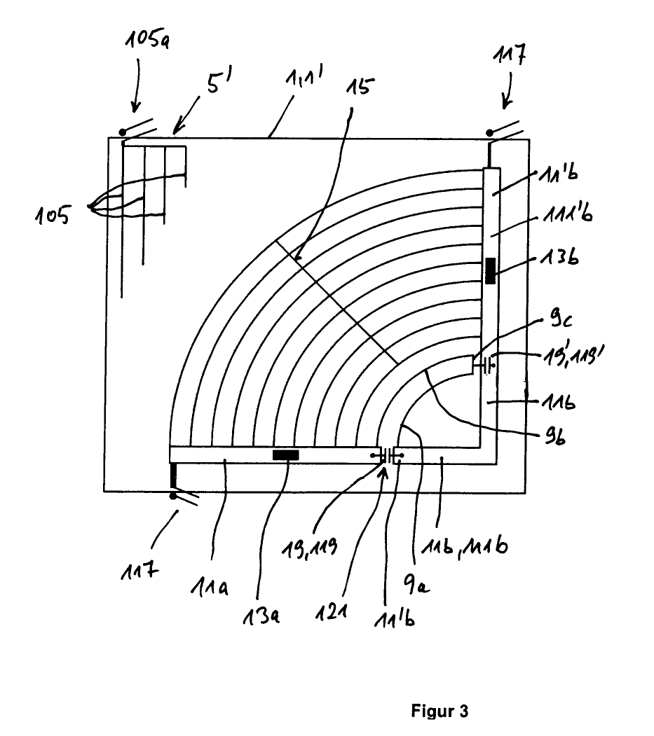

FIG. 3 shows another modified exemplary embodiment according to the invention, in which the bus bars are provided on two sides of a rear window that are not opposite each other;

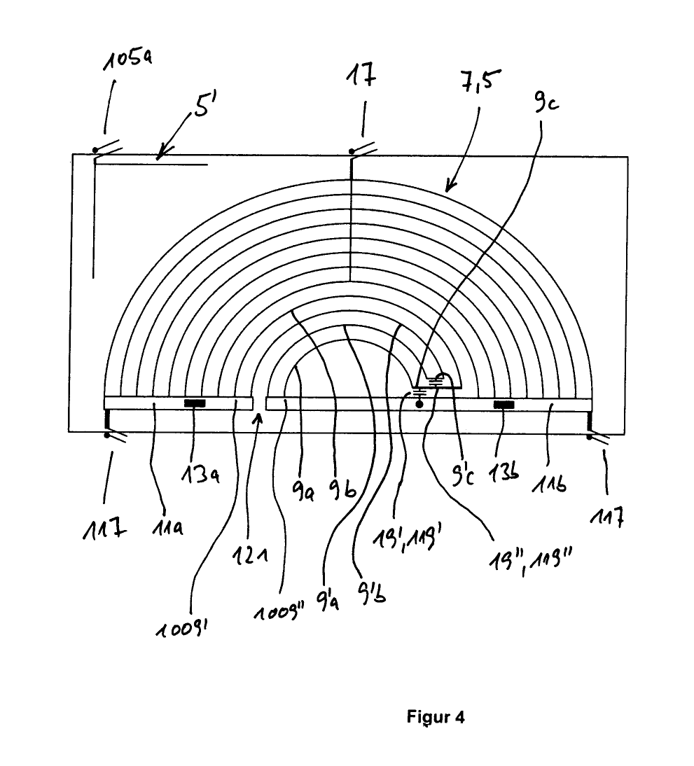

FIG. 4 shows a further exemplary embodiment according to the invention that is slightly modified compared with FIG. 2 having a capacitive connection between two heating conductors, which are each connected to the respective two bus bars.

FIG. 1 shows in a schematic front view a window 1, for example of a motor vehicle, in particular a rear window 1′, which viewed schematically has an upper limit or limiting edge 1a, a lower limit or limiting edge 1b and a left-hand and a right-hand limit or limiting edge 1c and 1d respectively. In practice, these limiting edges are not in mutually parallel pairs, but are curved, rather approximating a trapezium or such like, because the windows usually get wider from top to bottom. In this respect there are no restrictions on the shape of the windows, so that even any curved limiting lines are possible.

A heating panel 7 is incorporated in the window of this form, said heating panel comprising a multiplicity of conductors 9 running outside or inside the window, which, in the exemplary embodiment shown in FIG. 1, run between a first and a second bus bar 11, in the exemplary embodiment shown between the left-hand bus bar 11a and a right-hand bus bar 11b adjacent to this. In the exemplary embodiment of FIG. 1, the heating panel 7 forms an antenna panel 5.

Each bus bar is assigned a supply line or power line 13a and 13b respectively, where, for example, the power line 13a is connected to the on-board battery power supply of the motor vehicle (usually the positive pole), and the other supply line 13b is connected to the other pole, for example the ear-body ground. Blocking circuits are usually located in the supply lines or power lines in order to prevent any escape of high frequency currents.

In the exemplary embodiment shown, owing to the geometry chosen for the heating panel, the individual conductors 9 are provided such that they run in a more or less equidistant arrangement between the bus bars, where a constantly uniform separation is not absolutely essential or at least not over the entire length of the individual heating conductors. Here, the geometry is chosen such that the two bus bars 11a and 11b are provided along one side of the window, in the exemplary embodiment shown in the region of the lower limit 1b, said bus bars being arranged symmetrically about a central plane of symmetry 14. The heating conductors 9 are here designed e.g. in the shape of a circular arc or even a semicircle in the exemplary embodiment shown, but can also have other curved shapes, such as a semi-oval shape etc., where the radii or diameters increase in length from the inner region outwards, so that the length of the individual heating conductors also increases from the inner region outwards.

In addition, a secondary conductor 15 is provided, which connects together the outer eight heating conductors in the centre and acts as an antenna tap-off line 17. Such a secondary conductor 15 lies, from the direct current perspective, on equipotential surfaces, which means that it has no effect on the direct current distribution of the heating panel. Nevertheless, it is a well-known fact that this improves the antenna reception characteristic. In addition, two further antenna tap-off lines 117 are connected to the respective opposite outer ends of the two bus bars 11a and 11b, although they can also be connected to another point of the bus bar or of the heating panel, and if applicable they can even coincide with the supply lines 13a or 13b.

Hence, in the exemplary embodiment shown, two heating-panel connections 13a and 13b and three antenna tap-off connections 17, 117 are provided. However, the number of connections may also be different, in particular, for example, when split heating panels are provided, which do not run just between two bus bars (known for example from DE 100 33 336 A1 or DE 43 21 805 A1).

Furthermore, in the exemplary embodiment shown, the two bus bars 11 are provided lying preferably in a horizontal line, and specifically in an axial extension of each other (even if the plan view of the window may be curved), said two bus bars being connected together at their inner end 11′a and 11′b via an interconnected capacitance 19.

There is hence a direct connection between the two bus bars 11a and 11b with the interconnection of a capacitance. This capacitance is arranged here so that virtually the shortest distance between the two bus bars is bridged. The capacitance is hence to be provided preferably still within the height of the window 1, even if obviously wiring can run out from the window area and back to the window area again to the respective other bus bar.

A certain deterioration in the antenna characteristic is detectable, however, with an increase in the connection path 21 running via the capacitance.

The gap 121 formed between the two ends 11′a and 11′b of the two bus bars 11a and 11b is designed to be small and has a length between the two bus bars, which is preferably equal to less than five times, four times, in particular less than three times or even twice, the distance between two adjacent heating conductors.

The capacitance can be composed of one or more discrete or lumped components, preferably of one capacitor 119 connected by wiring. It can preferably be designed as an SMD, although a capacitance made from capacitor surfaces or films applied parallel to the window surface and having at least two coplanar capacitive surfaces and an interconnected insulating surface is also possible. The capacitance can also be composed of an electrolytic capacitor having suitable wiring, of ceramic capacitors, of flexible printed circuit boards etc. There are no restrictions to specific capacitor models or capacitor types.

The capacitances in question should preferably lie between 50 pF and 10 μF, in particular in a range of greater than 0.1 nF or 0.1 μF and in particular greater than 0.5 nF or greater than 0.5 μF.

Hence, if possible, the capacitances shall be greater than 50 pF, 0.1 nF, 0.25 nF, 0.5 nF, 1 nF or also greater than 3 nF or 5 nF or greater than 0.1 μF, 0.25 μF, 0.5 μF, 1 μF or also greater than 3 μF or even 5 μF. On the other hand, capacitance values less than 10 μF , less than 5 μF, less than 1 μF and, if applicable, even less than 0.5 μF are practical and possible for specific applications.

An antenna having such a design is especially suitable in the frequency range of 125 kHz to 1.6 GHz, for example. In the broadcasting region, the antenna is particularly suitable for frequency bands of 70 MHz to 900 MHz.

Since in the exemplary embodiment shown in FIG. 1, the inner heating conductors are very much shorter than the outer conductors, the outer, i.e. longer, heating conductors would need to be made increasingly thick in order to produce comparable heating powers for each heating conductor.

In order to even out the length of the heating conductors, i.e. to avoid sharp differences in the heating conductor thicknesses, it is provided in the exemplary embodiment shown in FIG. 2 that, for example, the two inner heating conductors are connected together. In the exemplary embodiment shown in FIG. 2, it is hence provided that the two inner heating conductors 9a and 9b adjacent to the right-hand bus bar 11b are not connected to this bus bar but are connected together via a cross-connection 9c, i.e. via a cross-connection 9c that runs, in the exemplary embodiment shown, at a short distance from, and parallel to, the bus bar 11b. The connection points 109′ and 109″ of these two heating conductors to the bus bars 11a and 11b are provided in the exemplary embodiment shown immediately at the two facing ends 11′a and 11′b of the two bus bars 11a and 11b, which for this geometry are designed to be of different length. Hence a heating conductor is obtained, which is composed of the heating conductor 9a, the connection, or the connecting section 9c as it is called, and the further returning heating conductor 9b, this heating conductor being connected, like said capacitance 19, to the two end sections 11′a and 11′b, spaced a short distance apart, of the bus bars 11a and 11b.

In this case, as a further measure that improves the antenna characteristic, an additional capacitance 19′ is provided, which is now connected and/or formed between the connection 9c of the two connected-together heating conductors 9a and 9b at one end and the adjacent bus bar 11b at the other end. It is also preferable here to use a lumped or discrete component in the form of a capacitor 119′ having appropriate connection points or appropriate wiring.

It is also shown in the drawing that the additional capacitance 19′, preferably in the form of an additional capacitor 119′, is connected between the one bus bar 11b and a preferably central section of the continuous heating conductor, where the central section 9c, which connects the two heating wires 9a and 9b, lies preferably between 20% and 80% of the total length of the heating wire formed from the heating wires 9a, 9b and the connecting line 9c, i.e. in the region of greater than 20%, in particular greater than 30%, 40%, 50%, calculated from the one connection end, and less than 80%, in particular less than 70%, 60% or 50%, calculated from the second connecting end. In the exemplary embodiment shown, the connecting section 9c lies in a range of 40% to 50% of the total length of this heating wire formed from the heating wires 9a, 9b and the connecting section 9c.

The example described having the connection 9c can also be applied to other heating conductors and is not restricted only to the two innermost heating conductors.

FIG. 2 also shows that in addition to the heating panel connected as an antenna panel, an additional second, separate antenna panel 5′ having antenna conductors 105 is also provided, which, for example, has an additional connection 105a for connecting a downstream receiver (for example a car radio).

It is also apparent that as a result of the specific arrangement of the antenna and heating panel according to the exemplary embodiment of FIG. 2, there is the potential to design the bus bars to have different lengths, so that the innermost heating conductor 9a does not need to be taken back over a specific distance to the right-hand second bus bar 11b. Any variations of this are possible and conceivable however.

In addition, it shall be mentioned that also a plurality of capacitances and/or capacitors can potentially be connected in series along the connection path 21 between the two bus bars 11a and 11b, and here even taps and connections to the car-body ground that lie between the capacitances are possible. It is also possible to connect further components such as inductors additionally and in series with the at least one capacitance along the connection path 21 between the two bus bars 11a and 11b. A connection between the two bus bars and the interconnection of capacitances via ground is not possible, however. The same applies also to the additional capacitance 19′, 119′, which is provided between two connected-together heating conductors and a bus bar (if necessary, a plurality of further pairs of heating conductors can be connected together, so that also a plurality of further capacitance bridges can be provided).

As can be seen from FIG. 2, the connection 9c is preferably aligned parallel to the adjacent bus bar 11b and lies there at a short distance from the bus bar 11b. This distance between the connection 9c and the adjacent bus bar 11b shall preferably be less than 80%, in particular 60%, 45%, 20% or even less than 10% of the length of the connection 9c.

In a variation of the exemplary embodiment shown, however, the two bus bars could also be provided on different sides of the window 1 that are not opposite each other. Hence the bus bar 11a shown in the further exemplary embodiment of FIG. 3 is, for instance, provided in the region of the lower limit 1b of the window 1, whereas the second bus bar 11b is arranged, for example, on the right-hand edge 1d of the window 1 running preferably in a vertical direction. In this case, curved heating conductors in the shape of circular or oval arcs are thus provided.

In the exemplary embodiment shown in FIG. 3, once again the two innermost heating conductors 9a and 9b are connected together at one end via a cross-connection 9c, and their opposite heating-conductor ends are connected to the two bus bars 11a and 11b respectively, where again in this case the two bus bars terminate at a short distance from each other and said capacitance 19 in the form of the capacitor 119 is connected along the connection path 21 in the gap 121 between the two bus bar ends 11′a and 11′b. In the exemplary embodiment shown, the bus bar 11b provided mainly on the right-hand side 1d on the window 1 by its section 11′b is additionally provided with an extension 111b at right-angles, which in turn runs along the lower window edge 1b in a direct extension of the first bus bar 11a provided there.

A longer heating conductor is again created here by said connection 9c between the two innermost heating conductors 9a and 9b, as a result of which the thicknesses of the heating wires need not vary so sharply from the inner region outwards because of the different lengths. Said connection 9c between the two innermost heating conductors 9a and 9c is in addition again electrically connected to the right-hand bus bar 11b via an additional capacitance 19′ in the form of a capacitor 119′.

In this exemplary embodiment, once again the outer heating conductors 9 (except the two innermost connected-together heating conductors 9a and 9b) are connected via a secondary conductor 15, which hence lies on the equipotential surfaces, which means that no cross-currents flow between the individual heating conductors.

Finally, FIG. 4 is considered, which shows a slightly modified exemplary embodiment of FIG. 2.

In the exemplary embodiment shown in FIG. 4, once again, like the exemplary embodiment of FIG. 2, two heating conductors 9a and 9b shaped as concentric circular arcs, are likewise connected together via a central section 9c, where a capacitance 19′ is connected between this central section 9c and the one bus bar 11b.

In this exemplary embodiment, between the two said heating conductors 9a and 9b, another two additional heating conductors 9′a and 9′b are connected together via an intermediate section 9′c, where a capacitance 19″, preferably in the form of a capacitor 119″, is additionally connected between this intermediate section 9′c and the aforementioned intermediate section 9c (which connects the two other heating conductors 9a and 9b). This variant can also be provided as an alternative or in addition to the other capacitances 19, 19′. In the exemplary embodiment shown, the two intermediate sections 9c and 9′c are designed to run parallel to each other and parallel to the adjacent bus bar 11b. The two additional heating wires 9′a and 9′b are also connected to connection points 1009′ and 1009″ adjacent to the connection points 109′ and 109″ respectively on the two bus bars 11a and 11b.

As already mentioned, the heating panel and/or antenna panel can also include for the arrangement other curved shapes, also, for example, trapezoidal heating conductors. A further number of secondary connection lines running across the equipotential surfaces may also be provided. In addition, said power lines can have a different design. Furthermore, as shown in the beginning in FIG. 3, additional antenna panels 105 having a different shape can also be provided.

In each case, the invention makes it possible to achieve a lower frequency dependence and hence a higher bandwidth for the antenna reception and to improve the resonant behaviour.

The exemplary embodiments have been described for the case in which a capacitance 19, 19′and 19″ respectively is connected between each of the connection points in question, i.e. between the two connection points of the bus bar, between a central section of a heating conductor and a bus bar, or between two central sections of two heating conductors. Each of the capacitances in question can also be connected to at least one further additional component, preferably to an inductance or inductor, which is preferably connected in series with the capacitance concerned, i.e. in particular producing a series resonant circuit. In particular along the connection path 21, a capacitance and an inductance or an inductor can hence be connected directly in series.

1. Antenna panel for a motor-vehicle window comprising:
at least one heating panel having a plurality of conductors,
the conductors that form the at least one heating panel being provided between at least two bus bars running inside or on the window, in an equidistant arrangement,
the heating panel is entirely or partially connected as an antenna panel, and/or at least one separate antenna panel having at least one antenna conductor is provided at least in addition to a heating panel,
all of the bus bars being provided on one side of the window or on two sides of the window that are not opposite each other,
at least one capacitance being connected in a direct connection between one of the at least two bus bars and at least one central section, formed between 20% and 80% of the total length of a heating wire, of the heating wire,
the at least one capacitance being greater than 50 pF.

2. Antenna panel according to claim 1, wherein at least one capacitance is connected between at least two central sections, formed between 20% and 80% of the total length of two heating wires, of the heating wires.

3. Antenna panel according to claim 2, wherein the at least one capacitance is connected in a direct connection between the associated connection points on the two central sections of the heating wires.

4. Antenna panel according to claim 1, wherein at least one capacitance is connected between the at least two bus bars.

5. Antenna panel according to claim 1, wherein the at least one capacitance is connected in a direct connection between the associated connection point on the bus bar and the relevant central section of the associated heating wire.

6. Antenna panel according to claim 1, wherein the at least one capacitance is composed of a discrete component, i.e. a capacitor.

7. Antenna panel according to claim 6, wherein the capacitance comprises an electrolytic capacitor, a ceramic capacitor, a surface mount device (SMD) or of insulated conductor tracks arranged parallel to the window plane in layers one on top of the other.

8. Antenna panel according to claim 1, wherein the capacitance is less than 10 μF.

9. Antenna panel according to claim 1, wherein at least another one further component is connected in series with the at least one capacitance the component including an inductor or an inductance forming a series resonant circuit.

10. Antenna panel according to claim 1, wherein two heating conductors are provided, which at least over some of their length run adjacent and equidistant to each other, and which are connected together via a connecting section at their one end region, extending their total heating-conductor length, whereas the respective opposite ends of the two heating conductors are being each connected to one of the two bus bars.

11. Antenna panel according to claim 10, wherein the connecting section runs parallel to an adjacent bus bar and/or that the two connecting sections run parallel to each other.

12. Antenna panel according to claim 10, comprising two pairs each comprising two heating conductors, which at least over some of their length run adjacent and equidistant to each other, and which are connected together in each case via a connecting section at their one end region, extending their total heating-conductor length, whereas the opposite ends of the respective two pairs of heating conductors are each connected to one of the two bus bars, and in that the two connecting sections are connected by the at least one capacitance.

13. Antenna panel according to claim 11, wherein the two pairs each comprising two heating conductors including their respective associated connecting sections are electrically connected only at their ends to the respective bus bar and with their associated connecting section only to the at least one capacitance.

14. Antenna panel according to claim 10, wherein the one pair of heating conductors, including the associated connecting section, lies physically between the two connected-together additional heating conductors, including the associated connecting section.

15. Antenna panel according to claim 10, wherein the connecting section is at a distance from the adjacent bus bar that is less than the length of the connecting section that is less than 80%, 60%, 40%, 20% or even less than 10% of the length of the connecting section.

16. Antenna panel according to claim 1, wherein the adjacent ends of the at least two bus bars lie at a short distance apart, where the gap is equal to less than five times, less than four times, less than three times or less than twice the distance between two adjacent heating conductors.

17. Antenna panel according to claim 16, wherein the gap between the first and second bus bar is provided so that one of two adjacent heating wires connected together via the connection is connected to the end of the first bus bar, and the other heating wire is connected to the end of at least one further bus bar.

18. Antenna panel according to claim 1, wherein the two bus bars are provided on or inside the window symmetrically about a plane of symmetry running vertically.

19. Antenna panel according to claim 1, wherein the at least two bus bars are arranged on the same side of the window, on the lower edge region adjacent to the lower limit of the window.

20. Antenna panel according to claim 1, wherein a bus bar is provided adjacent to the left-hand or right-hand limit.

21. Antenna panel according to claim 1, wherein at least one bus bar comprises sections oriented in two angles with respect to each other, where one section is arranged on one side of the window and the other section is arranged on another adjacent side of the window.

22. Antenna panel according to claim 21, wherein the one section of the bus bar is arranged on the same side of the window on which the first bus bar is also arranged.

23. Antenna panel according to claim 1, wherein at least one secondary conductor is provided, via which at least some of the heating conductors are connected across equipotential surfaces.
